(19) United States
(12) Patent Application Publication
(10) Pub. No.: US 2012/0315448 A1
(43) Pub. Date: Dec. 13, 2012

(54) METHOD FOR MAKING FOAMED SYNTHETIC BOARDS

(75) Inventors: Vincent Navez, Bonlez (BE); David Brull, Limbourg (BE); Robert Frere, Plombieres (BE); Emmanuel Noël, Opprebais (BE); Denis Job, Angleur (BE); Jean-Pierre Mayeres, Eupen (BE)

(73) Assignee: NMC S.A., Eynatten (BE)

(21) Appl. No.: 13/581,041

(22) PCT Filed: Feb. 25, 2011
(86) PCT No.: PCT/EP11/52849

§ 371 Date: Aug. 24, 2012

(30) Foreign Application Priority Data
Feb. 25, 2010 (BE) 2010/0127

(51) Int. Cl. B29C 47/06; B32B 3/10

(52) U.S. Cl. 428/195.1; 264/45.9

(57) ABSTRACT

The invention relates to a method for making articles having a veined aspect that includes the steps of (a) extruding a layer of substantially transparent PMMA including pigmented granules in a first extruder, (b) extruding a polystyrene layer including a foaming agent in a second extruder, wherein the extrusions of steps (a) and (b) are carried out simultaneously as a co-extrusion.

### TECHNICAL FIELD

The present invention relates to a method for making UV-resistant foamed articles that exhibit a wood or veined aspect.

### BRIEF DESCRIPTION OF RELATED ART

According to US 2005/0003221 A1, it is known to produce polymeric articles notably for wall cladding, comprising a colored substrate layer, onto which is coextruded an essentially transparent and UV-resistant polymeric skin layer based on methacrylic acid which comprises striations or veins simulating the aspect of wood. These striations are obtained in the course of the extrusion by incorporating into the skin layer pigmented granules that are compatible with the polymer of the skin layer and which, at the melting temperature of the polymer based on methacrylic acid, do not soften and are dispersed only slowly.

According to this document the substrate layer can be practically any polymer, notably ABS. This document also suggests that the substrate may be in the form of a foam.

Similarly, EP 1 174 465 A1 describes a composite siding comprising a polystyrene and a thin protective layer of acrylic ester polymer, as well as a process for producing this siding. Although this document mentions that the polystyrene can be in the form of a foam, or can comprise blowing agents, no example relates to a siding whose substrate is a foam. Furthermore, no mention is made of the production of a veined aspect or the like.

It is generally accepted in the field that for coextruding two layers of different composition, it is vital that the two flows have approximately the same temperature and the same viscosity, or fluidity, cf. Kunststoff Taschenbuch, Hanser Fachbuchverlag; 26th edition, (June 1998), page 245, last sentence; Extrusion: The Definitive Processing Guide and Handbook (Plastics Design Library), 2005, pages 191-193, particularly p. 192, Fig. 20.1 1 and 20.12. In fact, according to the latter reference, not only is it necessary for the viscosities to be identical during the coextrusion, but also the processing temperature should suit each of the extruded resins. If this is not the case for at least one of the resins, then interfacial instabilities are observed and the sole remedy is to replace at least one of the polymers by a more appropriate polymer.

Moreover, it should also be noted that the two initially mentioned documents recommend choosing resins that allow the two layers to be extruded at the same temperature, see in particular [0040] of US 2005/0003221 A1, or to carry out the extrusion at the same temperature or at a similar temperature, see examples of EP 1 174 465 A1.

It seems clear that in the case of producing composites with a foamed core, the problem is even more exacerbated due to the fragility of the foam being formed and to its much reduced capacity to dissipate the excess heat brought by a (very) much hotter coextruded layer. In fact, on the one hand one can easily understand that a dense and too hot layer would heat up a layer of foam and destroy the cell structure, thereby permitting the gas to escape, and on the other hand it is generally accepted in the case in a coextrusion comprising (at least) one foamed layer, that it is vital to match as far as possible the flow behaviors and the softening characteristics of the skin resin to those of the foamed layer, i.e. to extrude the two components at approximately equal temperatures and fluidities, respectively, (and consequently in practical terms those of the foam) in order to avoid any collapse of the foam by overheating (see for example Herstellung, Eigenschaften and Anwendungen von Schaumstoffen aus extrusionsgeschaumtem Polystyrol, Dr. Trausch, Süddeutsches Kunststoff-Zentrum, 1978, page 02.2.6/24 chapter 6).

As a result, when trying to apply such a process to a foamed substrate, such as for example a foamed polystyrene (PS) substrate, it must be concluded that there is a very limited choice of available resins that will avoid the foam collapsing on contacting the skin layer in the course of the coextrusion. In fact, the temperature required to extrude for example a methacrylic layer is generally significantly higher than that for a PS foam.

Consequently, although the processes described in the abovementioned documents seem to be applicable for solid substrates, they are not necessarily appropriate for the case of foams without severe limitations on (at least) the nature of the skin resin. In fact, the obligatory incorporation of blowing agents reduces the viscosity of the resin. The required temperature within the melt for a given viscosity of the mixture of resin and blowing agent should therefore be (significantly) lower than in the absence of blowing agent. Consequently, in order to maintain a given temperature within the melt, a resin with a (significantly) lower MFI would have to be chosen to compensate for the loss of viscosity due to the added blowing agent.

However, as the MFI cannot be freely adapted without negatively affecting the quality of the foam, the person skilled in the art (if he does not want to adapt the nature of the resin(s)) therefore has nonetheless the choice of lowering the processing temperature of the skin resin or to run the foamable resin at a temperature in the melt that is clearly too high.

Lowering the processing temperature of the skin resin is not only contrary to the generally accepted principles of the technology, but also creates significant interfacial problems, in particular in regard to the level of adhesion between the layers.

Likewise, by running (too) high a processing temperature for the foamable substrate, such as for example a foamed polystyrene (PS) substrate, i.e. at a temperature close to that of the PMMA skin, the foam would collapse during the coextrusion on contact with the methacrylic skin. In fact, it is recalled that the temperature required to extrude for example a methacrylic layer is generally significantly higher than that for a PS foam, generally by at least 40° C. or even more.

### BRIEF SUMMARY

Accordingly, the invention provides a process for preparing UV-resistant foamed articles applicable to foamed substrates even of low density, particularly of polystyrene, and which does not have the abovementioned disadvantages. Furthermore, the articles should have a veined or wood aspect.

In order to solve the abovementioned problem, the present invention proposes a process for making articles, for example profiles or boards that exhibit a veined aspect, comprising the steps of

(a) extruding a layer of essentially transparent PMMA comprising pigmented granules in a first extruder that comprises a first die head,

(b) extruding a polystyrene layer, preferably XPS, comprising a blowing agent, in a second extruder that comprises a second die head,

in which the extrusions of the steps (a) and (b) are made simultaneously in the form of a coextrusion, the temperature within the melt of the PMMA layer in the first extruder being greater than 40° C. or more, preferably at least 50° C., than the temperature within the melt of the polystyrene layer in the second extruder and the temperatures in the die head of the first and second extruders are essentially equal, i.e. they differ by not more than 10° C., preferably by not more than 5° C.

The PMMA (polymethyl methacrylate) that can be processed in the context of the present invention can be a methyl methacrylate homopolymer or a copolymer of methyl methacrylate and other comonomers, or even a mixture of such polymers. Accordingly, in the context of the present invention, the term PMMA can designate a composition of PMMA comprising one or a plurality of homopolymers and/or copolymers. The PMMA is preferably a copolymer of methyl methacrylate and of ethyl (meth)acrylate, still more preferably a copolymer of methyl methacrylate and of ethyl acrylate, e.g. CAS 9010-88-2. Such a PMMA is advantageously used in a mixture with one or a plurality of other compatible polymers, preferably one or a plurality of (grafted) copolymer(s) comprising acrylic and styrenic groups. A PMMA that is particularly well adapted for the present application is the PMMA commercialized under the trade name Solarkote® H.

The PMMA is coextruded with the layer of foamed polystyrene so as to form an article comprising a foamed substrate with an external skin of PMMA that is UV-resistant and more generally weather-resistant. The PMMA that is used is preferably essentially transparent, but it can be tinted or colored and can comprise, if needed or useful, other adjuvants and additives. The term “essentially transparent” or more simply “transparent” in this context signifies that the material allows at least certain wavelengths of visible light to pass through.

In the above process the PMMA, respectively the PMMA composition, generally exhibits a melt flow index (MFI) of at least 1, preferably at least 2.0, more preferably at least 3.0, in particular at least 4.0, advantageously at least 5.0 g/10 min, 230° C., 3.8 kg. Moreover, the melt flow index is generally 15 at most, preferably 14.0 at most, more preferably 13.0 at most, in particular 12.0 at most, advantageously at most 10.0 g/10 min, 230° C., 3.8 kg. Advantageously, the MFI of the PMMA is about 5.0 to 10.0 g/10 min, 230 ° C., 3.8 kg. The Melt Flow Index (MFI) or Flow Index (FI), also known by the names Melt Flow Rate (MFR) or Melt Index (MI), is a widely used method in the plastics industry for characterizing thermoplastic materials. It provides an estimation of their extrudability. This relatively simple and traditional method, described in the Specification ASTM D1238, can be easily used for quality control of production batches and of incoming materials.

The thickness of the layer of PMMA is advantageously between 50 μm and 500 μm, advantageously between 100 μm and 400 μm, preferably about 200 μm to 300 μm, particularly preferably with a constant thickness across the whole section. In practice the minimal thickness will generally be at least 100 μm if the UV stability of the PMMA is an important criterion.

The pigmented granules are preferably formulated as a masterbatch, comprising one or a plurality of pigments and of colorants in one or a plurality of polymeric base resins that are compatible with the PMMA. These pigmented granules are metered into the PMMA in the first extruder, preferably in a very small quantity, for example from 0.5% to 15% by weight of the PMMA composition.

In order to obtain a striated effect resembling for example wood grains, the pigmented granules should be imperfectly mixed in the PMMA. In fact, it is thereby possible to obtain “clouds” of imperfectly mixed colors/pigments in the PMMA during extrusion, thereby reproducing the striations present in real planks of cut wood.

The striation effect can be controlled or regulated by varying a plurality of different parameters or by combining a plurality of these various parameters.

One group of parameters that influence the formation of the striations and their aspect is the choice of the extruder and the operating procedure. Accordingly, the first extruder for extruding the PMMA layer is preferably a single screw extruder. Furthermore, the speed of rotation of this extruder is preferably very low, for example less than 20 rpm, advantageously even less than 10 rpm. In one advantageous embodiment of the process, the first extruder is a single screw extruder turning at a screw speed of less than 8 rpm.

Another group of useful parameters for varying the striation effect concerns the pigmented granules, i.e. their quantity, their granulometry and their composition both in the base resin as well as in the nature and content of pigment(s) and/or colorant(s). Thus, in a preferred embodiment, the pigmented granules have a MFI (melt flow index according to ASTM D1238) of less than 0.7, preferably less than 0.5, the MFI being particularly preferably between 0.05 and 0.4 g/10 min, 230° C., 3.8 kg. The MFI can be controlled in particular by the choice of the composition of the base resin of the pigmented granules.

In regard to the composition of the granules as far as the content of pigment(s) and/or colorant(s) is concerned, it is generally advantageous to use granules with a relatively high content of pigment(s) and/or colorant(s), in particular a pigment concentration of >10% by weight, preferably >15% by weight and most preferably >20% by weight, or even more. The pigmented granules can comprise any appropriate pigment or colorant, or mixtures thereof, for example carbon black, titanium dioxide, etc. The granules preferably comprise carbon black.

Different types of granules having a different composition of base resin and/or of pigment/colorant may also be used.

The granulometry of the pigmented granules is preferably between 1 and 6 mm, preferably between 2.5 and 5 mm, for example between 3 and 4 mm.

Moreover, the mixture of granules having a different color/pigmentation and/or a different MFI and/or a different granulometry can create even more varied and realistic effects.

The polystyrene that can be used for the extrusion of the foamed layer of polystyrene can be a homopolymer or copolymer of styrene. It is preferably a copolymer of styrene and one or more comonomers, for example butadiene, styrene-butadiene-styrene, acrylonitrile-butadiene, ethylene-propylene-diene (EPDM), . . . .

According to a first advantageous embodiment, the processed styrene polymer or polystyrene is selected from the group consisting of polystyrene (crystal), impact polystyrene based on butadiene (HIPS), acrylonitrile-butadiene-styrene (ABS), styrene-butadiene-styrene (SBS), styrene-ethylene-butadiene-styrene (SEBS), impact polystyrene based on ethylene-propylene-diene and mixtures thereof.

A plurality of types of polystyrene of different viscosities and hence of differing molecular weights can also be used, alone or in a blend, with other copolymers of styrene and a monomeric diene. Exemplary suitable copolymers are impact polystyrene based on butadiene (HIPS), impact polystyrene based on ethylene-propylene-diene (EPDM), acrylonitrile-butadiene-styrene (SBS), styrene-ethylene-butadiene-styrene (SEBS) or mixtures thereof.

In order to further improve (the realism of) the aspect of the obtained article, the polystyrene can be colored in the melt with suitable pigments and/or colorants that are well known to the person skilled in the art.

The foaming agent can be a physical or chemical foaming agent or a combination of two or more physical and/or chemical foaming agents. In general, they are those commonly used in manufacturing foamed polystyrene. Suitable physical foaming agents include agents that are gaseous under ambient temperatures and pressures, such as CO₂, nitrogen, lower alkanes, for example butane or isobutane, etc. and agents that are liquid under ambient temperatures and pressures, such as pentane, hexane, etc. The chemical foaming agents include azodicarbonamide, a combination of citric acid and sodium bicarbonate, OBSH, etc. The chemical agents can also be used as “active nucleating” agents in combination with one or more physical agents.

The amount of foaming agent to be used obviously depends on the nature of the foaming agent itself, but also on the required foam density. As an example, the percentage by weight of CO₂ in the case of a direct gassing is between 0.01% and 5%, preferably between 0.015 and 3%.

The thickness of the polystyrene layer primarily depends on the end use of the manufactured article. This thickness is significantly greater than that of the PMMA layer and will normally be between 5 mm and 20 cm (or more), preferably between 8 mm and 10 cm, particularly between 10 mm and 5 cm.

The process of the present invention is particularly suitable for foamed substrates with a density comprised between 40 kg/m³ and 550 kg/m³, preferably between 60 and 450 kg/m³ with fine cells from 5 to 200 μm and homogenously sized.

As mentioned above, the PMMA and polystyrene are extruded together in a coextrusion process. In the process according to the invention, as indicated previously, the temperature in the melt in the first extruder (PMMA temperature) is usually between 200 and 250° C., preferably between 210 and 240° C., and the temperature in the melt in the second extruder (PS temperature) is usually between 135 and 160° C., preferably between 140 and 155° C., whereas the temperature in the die head for the two extruders corresponds to that used conventionally for the PMMA. This can be carried out in a manner that is surprising for the person skilled in the art, in spite of the presence of foaming agent (the quantity of which being inversely proportional to the foam density) and the process developed in the context of the present invention enables products to be obtained with a regular surface appearance and a good interfacial adhesion—even with die head temperatures that are significantly higher than the usual temperature for polystyrenes of about 135° C. It is even more surprising that even at these exceptionally high temperatures and with lower foam densities, the foam does not collapse on contact with the layer of PMMA. Moreover, the adhesion between the two layers is surprisingly high.

The layer of PMMA is coextruded on at least one surface of the polystyrene foam. In an advantageous embodiment, the layer of PMMA is applied on at least two sides of the foam. The layer of PMMA preferably covers all sides (in the longitudinal direction of extrusion) of the polystyrene foam. In this context it should be noted that the layer of PMMA on the different sides can be produced by means of more than the first extruder and that the pigmented granules do not need to be introduced into each extruder. In this way, a striation effect can be obtained on only one or on a plurality of sides.

Finally, the rendering of the striation effect obtained with the above process can be further improved or made more realistic by providing a compression step, stamping, structuration or embossing, for example by means of a metal or elastomeric roller that has striations and channels in its throat.

Accordingly, the invention also relates to an article (in particular a plank or profile) produced with the process described in this document. In a preferred aspect, the invention enables the production of an article comprising a layer of PMMA exhibiting pigmented striations forming a wood grain or veined aspect, the layer of PMMA being co-extruded on at least one surface of a layer of foamed polystyrene.

Another aspect of the invention is the use of an article as described in this document for exterior applications, in particular shutters, screens, fences, sidings, cladding and exterior joinery, such as for example: flower pots, benches, garden chairs and tables, animal housing, garden sheds, etc.

Other features and characteristics of the invention will emerge from the preceding detailed description as a non-exhaustive illustration.

### DETAILED DESCRIPTION

### 1. Production Process:

### 1.1. Metering of the Components:

In order to accurately produce the desired composition, the components of the formulations are metered individually by means of a volumetric or gravimetric metering station.

### 1.2. First Extruder:

The thus-metered components of the first layer, viz. the PMMA and the pigmented granules, are supplied to the feed of a first extruder. This extruder is preferably a single screw extruder and can be for example a single screw “side-extruder” of ø 40 mm and L/D=23.5. In order to obtain the striation effect, there should be a limited mixing of the colored granules in the PMMA, for example by means of a slow screw speed (less than 8 rpm).

### 1.3. Second Extruder:

The components of the polystyrene layer are supplied to the feed of a second extruder. This extruder is preferably equipped with two screws that can be co-rotating or counter rotating, self-cleaning or not. The cylinder has a plurality of heating zones. The first part of the cylinder is heated to a high temperature in order to plastify the solid components metered to the feed zone, and to mix them to homogenize them all. At the point that is most favourable from the aspect of viscosity and pressure in the cylinder, a pressurized gas is injected through an injection port drilled into the cylinder. The gas has to be maintained in its condensed phase, in particular in a supercritical state in the case of CO₂ (see point 2.4). The mixture of the components and gas are mixed and pressurized in order to obtain a good homogeneity and an optimal dissolution of the gas in the melted mixture and to obtain a single phase. The subsequent cylinder zones are progressively colder in order to maintain the pressure required to solubilize the gas.

The compositionally and temperature homogeneous plastified single-phase mixture of polystyrene and gas then passes into the die head that is constituted by a die that guides the flow into the required foamed shape. The pressure drop incurred by the mixture on leaving the cylinder continually reduces the pressure of the mixture; at one point this pressure falls below the critical threshold, below which the previously dissolved gas supersaturates the mixture thereby affording gas bubbles that form a second discrete phase. In the ideal case, the formation of the primary bubbles must not occur too early, otherwise pre-foaming occurs yielding a misshapen and unstable foam that has a poor surface. The courses of action at the point where this critical de-mixing step occurs are multiple: viscosity of the components, tooling temperature, proportion of gas, die design, extruder output . . . all of these parameters have to be optimized for each foam profile.

### 1.4. Coextrusion:

The start-up is similar to the start-up of the foam extrusion without PM MA, in that it is only the temperature of the extrusion die head that passes to 210° C. for all the foam densities instead of 135° C.<T_{head}<160° C. The temperatures in the melt are the following: 210° C.<T_{PMMA}<240° C., 135° C.<Tₚₛ<160° C., and in fact are adjusted as a function of the final product density.

The PS can be foamed either by direct gasification or by a chemical blowing agent, and on all types of single- or twin-screw extruder that allow the Tₘₑₗₜ of the PS (or XPS, extruded polystyrene) to be well controlled as a function of the density.

The pressure of the PMMA before the flow channel where it is also distributed onto the (X)PS (still in the extrusion die head) is between 30 and 100 bar. The pressure of the (X)PS measured before the die head is between 20 and 100 bar, depending on the density and the cross section of the profile.

The layer of PMMA and the layer of polystyrene emerge at atmospheric pressure, at high temperature, and the layer of polystyrene expands. The viscosity of the cell walls in the layer of polystyrene increases on cooling and the migration of gas in the cells, causing the cell structure to solidify.

The dimensions of the PMMA-polystyrene foam assembly are controlled by passing it through a calibration system by means of a motorized take-off at the end of the extrusion line. The calibrators, optionally temperature-controlled for a more efficient control of the shape, particularly to begin with when the foam is the hottest, progressively give the assembly its definitive shape. The physical structure of the hot profile further improves the adhesion.

### 1.5. In-Line Decoration (Optional):

A selected portion of the coextruded article can be shaped, for example with a heated roller pressing against the PMMA layer or by a compression system travelling along with the profile, or by any other process known to the person skilled in the art.

### 1.6. Take-Off and Cutting:

The coextruded article is pulled by a single or twin motorized take-off, depending on the number of profiles extruded in parallel. The profile is then cut to size by a saw that accomplishes a vertical cut.

### 1.7. Off-Line Decoration (Optional):

Decorative logos or intaglio structures can be printed on a chosen portion of the cut profile, for example with a heated roller pressed against the locally pre-heated article or by a compression system or by any other process known to the person skilled in the art.

### 2. Raw Materials:

### 2.1. PMMA:

The PMMA used for the skin layer that affords UV and weather resistance is a homopolymer or copolymer of methyl methacrylate having an MFI of about 1 to 8 g/10 min, 230° C., 3.8 kg.

### 2.2. Pigmented Granules:

The pigmented granules comprise PMMA as the base resin and pigments such as carbon black. The PMMA color masterbatch for producing the “wood effect” preferably has an MFI<<0.7 g/10 min (230° C., 3.6 kg). The carbon black content of the latter is greater than 15% by weight.

### 2.3. Polystyrene:

Polystyrene is used as the base resin for the foam layer. The viscosity of the polystyrene is adapted as a function of the foam profile, the pressure required for obtaining a good quality, the desired extrusion rate. Various types of polystyrenes, differing in viscosity and therefore in molecular weight, having melt flow indices “MFI” from 1 to 25 g/10 minutes according to ASTM D1238, measured at 200° C. under a load of 5.0 kg, can be used alone or in blends. Copolymers of styrene and a monomeric diene which possess a better impact resistance and a better elasticity can also be added. For example: impact polystyrene based on butadiene (HIPS), acrylonitrile-butadiene-styrene (ABS), styrene-butadiene-styrene (SBS), styrene-ethylene-butadiene-styrene (SEBS), impact polystyrene based on ethylene-propylene-diene (EPDM), also having variable melt flow indices (MFI), adapted according to the resulting foam.

Recycled material that is compatible with the set of components can also be added, for example scrap pre-ground, degassed and densified foamed profiles.

### 2.4. Gas:

The preferred foaming agent used is CO₂. It is stored in a reservoir under pressure and temperatures at which it remains in the liquid state. The temperature must not go above 31.1° C.; above this the CO₂ becomes supercritical and therefore has a density much lower than the liquid, making pumping difficult. The CO₂ is pumped through conduits that are chilled to well below the critical temperature in order to maintain the liquid state up to the device that regulates the rate of injection. This is a flowmeter that functions according to the Coriolis Effect, which relates the mass of metered gas per unit time to a change of speed of vibration induced by the passage of fluid in a vibrating conduit. As this flowmeter only functions for liquids, it is vital that the CO₂ remains in the liquid state. The liquid CO₂ is then transferred into the extruder cylinder through an injection port, equipped with a non-return valve.

### 2.5. Additives:

a. Nucleating Agent:

The foam cells are adjusted with the help of a compound that favorizes a homogeneous distribution of the cells in the foam. It can be a passive product that does not react chemically, such as talc, calcium carbonate, silica, . . . “Active” products can also be employed which decompose under the action of heat by emitting a gaseous phase. The reaction favorizes the homogeneous nucleation as well as the presence of finely divided domains of gas. The combinations of citric acid and sodium bicarbonate, azodicarbonamide, OBSH, . . . are well known.

b. Process Aid Additives:

These are compounds that facilitate the extrusion of the polystyrene mixture by internal or external lubrication. They are generally low molecular weight compounds. Among the known compounds, may be cited the esters of C4-C20 monohydric alcohols, the fatty acid amides, polyethylene waxes, oxidized polyethylene waxes, styrenic waxes, C1-C4 alcohols, silicone compounds etc. These compounds can be added to the mixture at the beginning of the extruder in the form of a polystyrene-based masterbatch, or injected in liquid form into the extruder, or even regularly and precisely injected through a distribution ring at a suitable point in the extrusion tooling so as to regularly and exclusively coat the flow channel of the die to form a film having a very low coefficient of friction.

c. Pigments:

The bulk of the polystyrene foam can be uniformly colored by adding pigments to the feed zone of the second extruder.

d. Other additives:

The following may be cited in a non-exhaustive manner:

Flame retardants, halogenated [chlorinated, brominated, fluorinated . . . ] or non-halogenated, [hydroxides, phosphates, expandable graphite, . . . ];

### Antioxidants;

Diverse mineral fillers;
Reinforcing fibers (glass, cellulose, . . . )
Additives acting on the viscosity in the molten state (high molecular weight acrylic copolymers)

1. A method for making articles having a veined aspect that comprises the steps of
(a) extruding in a first extruder a layer of transparent PMMA comprising pigmented granules,
(b) extruding in a second extruder a polystyrene layer comprising a foaming agent,
wherein the extrusions of steps (a) and (b) are carried out simultaneously by co-extrusion, wherein the temperature in the melt of the PMMA in the first extruder is greater by at least 40° C. than the temperature in the melt of polystyrene in the second extruder and wherein the difference of the temperatures in the extrusion head of each of the first and second extruders is less than 10° C.

2. The method according to claim 1, wherein the temperature in the melt in the first extruder is between 200 and 250° C., and the temperature in the melt in the second extruder is between 135 and 160° C.

3. The method according to the claim 1, wherein the PMMA has a melt index (melt flow index according to ASTM D1238, MFI) between 1 and 15 g/10 min, 230° C., 3.8 kg.

4. The method according to claim ,1 wherein the pigmented granules have a melt index (melt flow index according to ASTM D1238, MFI) of less than 0.7 g/10 min, 230° C., 3.8 kg.

5. The method according to claim 1, wherein the thickness of the layer of PMMA is between 50 μm and 500 μm, and the thickness of the layer of foamed polystyrene is between 5 mm and 20 cm.

6. The method according to claim 1, wherein the concentration of pigments in the pigmented granules is >10% by weight.

7. The method according to claim 1, wherein the pigmented granules have a granulometry between 2.5 mm and 5 mm.

8. The method according to claim 1, wherein the pigmented granules represent 0.5% to 15% by weight of the PMMA and comprise carbon black.

9. The method according to claim 1, wherein the foaming agent is a physical or chemical foaming agent or a combination of two or more physical and/or chemical foaming agents.

10. The method according to claim 1, wherein the first extruder is a single screw extruder turning at a low rotational speed, with a rotational speed of less than 8 rpm.

11. The method according to claim 1, wherein the polystyrene is coloured throughout.

12. An article prepared with the method according to claim 1.

13. An article comprising a layer of PMMA exhibiting pigmented striations forming a veined aspect, the layer of PMMA being co-extruded on a layer of foamed polystyrene.

14. The article according to claim 14, wherein the density of the foamed polystyrene is between 40 and 550 kg/m³.

15. The article according to claim 13 wherein the article is configured for exterior applications, comprising at least one of shutters, screens, fences, facade claddings and exterior joinery.

16. The article according to claim 14 wherein the article is configured for exterior applications, comprising at least one of shutters, screens, fences, facade claddings and exterior joinery.

17. The method according to claim 1, wherein the difference of the temperatures in the extrusion head of each of the first and second extruders is less than 5° C.
